(19) United States
(12) Patent Application Publication
(10) Pub. No.: US 2005/0053010 A1
(43) Pub. Date: Mar. 10, 2005

(54) Communication protocol determination

(76) Inventor: Carey W. Smith, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/646,958

(22) Filed: Aug. 21, 2003

(51) Int. Cl. H04L 12/26

(52) U.S. Cl. 370/252; 370/389

(57) ABSTRACT

In one embodiment, a method is provided. The method of this embodiment includes determining, at least in part at a first node, at least one communication protocol via which a second node is capable of communicating with the first node. In this embodiment, the determining of the at least one communication protocol may be based at least in part upon at least one parameter received from the second node during an initialization of communication between the first node and the second node. The at least one parameter may specify, at least in part, the at least one communication protocol. Of course, many alternatives, variations, and modifications are possible without departing from this embodiment.

### FIELD

This disclosure relates to the field of communication protocol determination.

### BACKGROUND

In one conventional digital subscriber line (DSL) network, the network includes customer premises equipment (CPE) coupled via a subscriber line to a telephone central office (CO). The CPE exchanges frames with the CO, via the subscriber line, that encapsulate data and commands. For example, the CPE encapsulates, in accordance with one or more communication protocols, data and commands in frames and transmits the frames to the CO. The CO de-encapsulates, in accordance with these one or more communication protocols, the data and commands from the received frames. Also, for example, the CO encapsulates, in accordance with these one or more communication protocols, data and commands in frames, and transmits these frames to the CPE. The CPE de-encapsulates, in accordance with these one or more communication protocols, the data and commands from these received frames. Typically, the one or more communication protocols in accordance with which the CO is capable of encapsulating and de-encapsulating such data and commands are predetermined.

In this conventional network, if the one or more predetermined communication protocols in accordance with which the CO encapsulates and de-encapsulates such data and commands are known prior to constructing the network, then a user may select CPE that is capable of implementing these one or more predetermined communication protocols, and the one or more communication protocols implemented by the CPE, so as to be compatible with these one or more predetermined communication protocols. Alternatively, in this conventional network, if the one or more predetermined communication protocols in accordance with which the CO encapsulates and de-encapsulates such data and commands are not known, then the user may employ trial-and-error experimentation to determine these one or more predetermined communication protocols, and based on the results of such experimentation, the user may select CPE that is capable of implementing these one or more predetermined communication protocols, and may configure the CPE to communicate in accordance with these one or more predetermined protocols.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a network.

FIG. 2 illustrates a system embodiment.

FIG. 3 illustrates program processes that may reside in the system embodiment of FIG. 2.

FIG. 4 is a flowchart illustrating operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

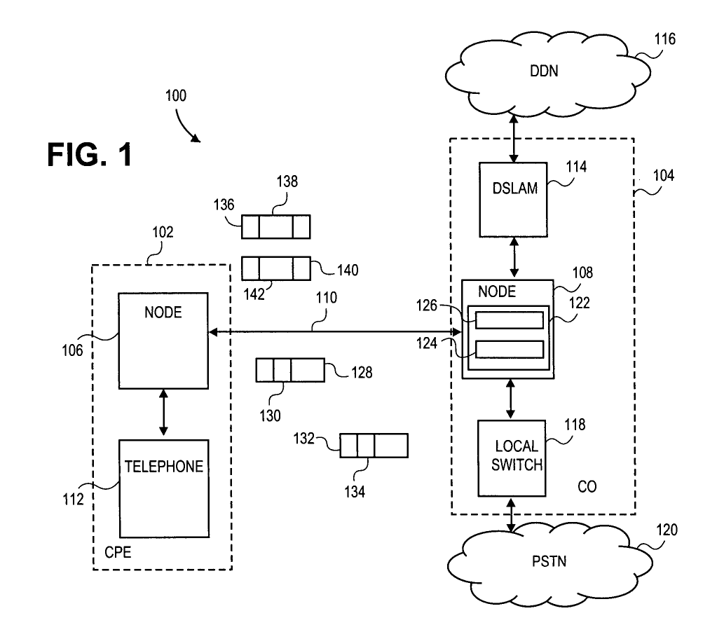

FIG. 1 illustrates one embodiment of a network 100. In this embodiment, network 100 may be, for example, a DSL network, that may comprise, for example, CPE 102 and CO 104. CPE 102 may comprise network node 106, and CO 104 may comprise network node 108. In this embodiment, nodes 106 and 108 may be communicatively coupled together via telephone subscriber line 110 that may comprise a pair of twisted copper wires used in conventional telephonic voice communication, such as, for example, a plain old telephone service (POTS) twisted wire pair communication line.

CO 104 also may comprise a local switch 118, via which node 108 may be communicatively coupled to public switched telephone network (PSTN) 120. Local switch 118 may comprise, for example, a local telephonic switch bank. Additionally, CO 104 may comprise a DSL access multiplexer (DSLAM) 114, via which node 108 may be coupled to digital data network (DDN) 116. DDN 116 may comprise, for example, a private data network or public data network, such as, the Internet.

In this embodiment, node 108 may comprise, for example, DSL modem operative circuitry 122. Operative circuitry 122 may comprise DSL splitter circuitry 124 and DSL modem transceiver circuitry 126.

In operation of network 100, node 106 and node 108 may communicate with each other by generating frames and exchanging these frames between nodes 106 and 108 in a manner that is compatible and/or complies with an asymmetric DSL (ADSL) communication protocol, such as, for example, the ADSL communication protocol described in Frank Van der Putten, “ADSL: G.adslplus, ASYMMETRIC DIGITAL SUBSCRIBER LINE (ADSL) TRANSCEIVERS—EXTENDED BANDWIDTH (ADSLplus),” ITU-T Draft RECOMMENDATION, OJ-R17, International Telecommunication Union—Telecommunication Standardization Sector, Standards Group 15, Oct. 21-25, 2002 (hereinafter referred to as the “ITU Standard”), and/or later developed versions of the ITU Standard. Of course, without departing from this embodiment, node 106 and node 108 may communicate with each other by generating frames and exchanging these frames between nodes 106 and 108 in a manner that may be compatible with and/or comply with other and/or additional DSL and/or other communication protocols. As used herein, a “frame” means a sequence of one or more symbols and/or values that may be encoded by one or more signals transmitted from at least one sender to at least one receiver.

POTS signals may also be exchanged, together with such frames, between nodes 106 and 108 via line 110. For example, telephone 112 may be communicatively coupled to node 106. Telephone 112 may generate POTS signals that may be transmitted via node 106 and line 110 to node 108. Splitter circuitry 124 comprised in modem circuitry 122 may transmit such POTS signals to local switch 118. Switch 118 then may transmit the POTS signals to PSTN 120.

Likewise, splitter circuitry 124 may receive POTS signals from PSTN 120 via local switch 118. Splitter circuitry 124 may transmit such POTS signals to node 106 via line 110. Node 106 may transmit the received POTS signals to telephone 112.

Splitter circuitry 124 also may transmit frames received from node 106 by node 108 to modem transceiver circuitry 126. Circuitry 126 may de-encapsulate data and/or commands comprised in such frames, and may transmit such data and/or commands via DSLAM 114 to DDN 116.

Likewise, node 108 may receive data and/or commands from DDN 116 via DSLAM 114 that are destined for node 106. Circuitry 126 may encapsulate such data and/or commands in one or more frames and may transmit these one or more frames to node 106 via line 110.

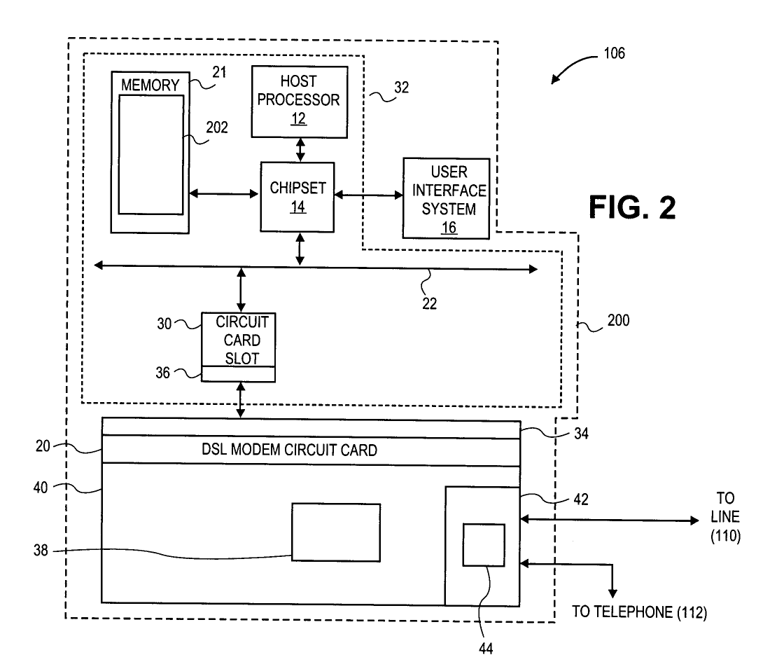

FIG. 2 illustrates a system embodiment that may be comprised in node 106. In this embodiment, node 106 may comprise operative circuitry 200. Operative circuitry 200 may include a host processor 12 coupled to a chipset 14. Host processor 12 may comprise, for example, an Intel® Pentium® III or IV microprocessor that is commercially available from the Assignee of the subject application. Of course, alternatively, host processor 12 may comprise another type of microprocessor, such as, for example, a microprocessor that is manufactured and/or commercially available from a source other than the Assignee of the subject application, without departing from this embodiment.

Chipset 14 may comprise a host bridge/hub system that may couple host processor 12, a system memory 21 and a user interface system 16 to each other and to a bus system 22. Chipset 14 may also include an I/O bridge/hub system (not shown) that may couple the host bridge/bus system to bus 22. Chipset 14 may comprise integrated circuit chips, such as those selected from integrated circuit chipsets commercially available from the Assignee of the subject application (e.g., graphics memory and I/O controller hub chipsets), although other integrated circuit chips may also, or alternatively be used. User interface system 16 may comprise, e.g., a keyboard, pointing device, and display system that may permit a human user to input commands to, and monitor the operation of, circuitry 200.

Bus 22 may comprise a bus that complies with the Peripheral Component Interconnect (PCI) Local Bus Specification, Revision 2.2, Dec. 18, 1998, available from the PCI Special Interest Group, Portland, Oreg., U.S.A. (hereinafter referred to as a “PCI bus”). Alternatively, bus 22 instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also alternatively, bus 22 may comprise other types and configurations of bus systems.

Processor 12, system memory 21, chipset 14, PCI bus 22, and circuit card slot 30 may be comprised in a single circuit board, such as, for example, a system motherboard 32. Circuit card slot 30 may comprise a PCI expansion slot that comprises a PCI bus connector 36. Connector 36 may be electrically and mechanically mated with a PCI bus connector 34 that is comprised in DSL modem circuit card 20. Slot 30 and card 20 may be constructed to permit card 20 to be inserted into slot 30. When card 20 is properly inserted into slot 30, connectors 34 and 36 may become electrically and mechanically coupled to each other. When connectors 34 and 36 are so coupled to each other, operative circuitry 40 in card 20 becomes electrically coupled to bus 22.

When circuitry 40 is electrically coupled to bus 22, host processor 12 may exchange data and/or commands with circuitry 38, via chipset 14 and bus 22, that may permit host processor 12 to control and/or monitor the operation of circuitry 40. Circuitry 40 may include modem transceiver circuitry 42. Circuitry 40 may comprise computer-readable memory 38.

Memory 21 and/or memory 38 may comprise read only, mass storage, and/or random access computer-readable memory. Memory 21 may store one or more program processes 202. Each of these program processes 202 may comprise one or more program instructions capable of being executed, and/or one or more data structures capable of being accessed, operated upon, and/or manipulated by processor 12, circuitry 42, and/or circuitry 40. The execution of these program instructions and/or the accessing, operation upon, and/or manipulation of these data structures by processor 12 and/or circuitry 40 may result in, for example, processor 12, circuitry 42, and/or circuitry 40 executing operations that may result in processor 12, circuitry 42, circuitry 40, circuitry 200, and/or node 106 carrying out the operations described herein as being carried out by processor 12, circuitry 42, circuitry 40, circuitry 200, and/or node 106. Without departing from this embodiment, all or a portion of program processes 202 may be comprised in memory 38.

Also without departing from this embodiment, instead of being comprised in card 20, all or a portion of operative circuitry 40 may be comprised in other structures, systems, and/or devices that may be, for example, comprised in motherboard 32, coupled to bus 22, and exchange data and/or commands with other components in operative circuitry 200. For example, without departing from this embodiment, chipset 14 may comprise one or more integrated circuits that may comprise all or a portion of operative circuitry 40. Other modifications are also possible, without departing from this embodiment.

In this embodiment, transceiver circuitry 42 may be communicatively coupled to line 110 and to telephone 112. Also in this embodiment, circuitry 42 may comprise DSL modem splitter circuitry 44. Telephone 112 may generate POTS signals that may be transmitted to circuitry 42. Splitter circuitry 44 may transmit such POTS signals to node 108 via line 110.

Likewise, circuitry 42 may receive POTS signals from node 108 via line 110. Splitter circuitry 44 may transmit such received POTS signals to telephone 112.

Additionally, transceiver circuitry 42 may generate one or more frames intended to be received by node 108. These frames may be transmitted via splitter circuitry 44 and line 110 to node 108. Likewise, one or more frames transmitted to node 106 from node 108 via line 110 may be transmitted to circuitry 42 via circuitry 44.

Of course, although splitter circuitry 44 has been described as being comprised in transceiver circuitry 42, circuitry 44 may not be comprised in circuitry 42 and/or may be comprised in other circuitry and/or components in node 106, without departing from this embodiment. Additionally, depending upon the particular functionality of circuitry 40 and/or circuitry 122, splitter circuitry 44 and/or splitter circuitry 124 may be eliminated from network 100, without departing from this embodiment.

In network 100, circuitry 126 may be capable of transmitting frames to circuitry 42 via a plurality of transmission channels; similarly, circuitry 126 may be capable of receiving frames from circuitry 42 via a different plurality of receiver channels. In this embodiment, circuitry 126 may be capable of communicating with circuitry 42 via these respective transmission and receiver channels in accordance with respective predetermined communication protocols associated with these channels. For example, in the embodiment, each of these one or more respective predetermined communication protocols may comprise, for example, one or more respective predetermined encapsulation and/or framing protocols that may be compatible and/or in compliance with either one or more Ethernet communication protocols or one or more Asynchronous Transfer Mode (ATM) communication protocols. For example, these one or more respective predetermined encapsulation and/or framing protocols may be compatible and/or in compliance with an Ethernet communication protocol described in, for example, Institute of Electrical and Electronics Engineers, Inc. (IEEE) Std. 802.3, 2000 Edition, published on Oct. 20, 2000, “A Method for Transmitting PPP Over Ethernet (PPPoE),” Request for Comments 2516, Networking Working Group, The Internet Engineering Task Force (IETF), published February 1999, and/or IEEE Draft Standard P802.3ah, Draft D1.732 (collectively and/or singly referred to hereinafter as “IEEE Standard”), and/or later developed versions of the IEEE Standard. Also for example, these one or more respective predetermined encapsulation and/or framing protocols may be compatible and/or in compliance with an ATM communication protocol described in, for example: “Classical IP and ARP over ATM”, Request for Comments 2225, Networking Working Group, IETF, published April 1998, “PPP Over AAL5,” Request for Comments 2364, Networking Working Group, IETF, published July 1998, and/or “Multiprotocol Encapsulation over ATM Adaptation Layer 5,” Request for Comments 2684, Networking Working Group, IETF, published September 1999 (collectively and/or singly referred to hereinafter as “ATM Standard”). Of course, these one or more respective predetermined communication protocols may comprise other and/or additional protocols without departing from this embodiment.

In network 100, circuitry 126 may be capable of encapsulating in one or more frames, in accordance with such one or more predetermined communication protocols, data and/or commands, and may transmit these one or more frames to circuitry 42 via one or more transmission channels associated with these predetermined communication protocols. Also in this embodiment, circuitry 126 may be capable of de-encapsulating, in accordance with one or more predetermined communication protocols, data and/or commands encapsulated in one or more frames received by circuitry 126 via one or more receiver channels associated with these one or more predetermined communication protocols. In this embodiment, circuitry 200 may be capable of determining, at least in part, the one or more predetermined communication protocols associated with these channels. After determining these one or more predetermined communication protocols, circuitry 200 may generate and transmit to circuitry 126 via one or more channels associated with these one or more protocols, one or more frames that may encapsulate data and/or commands in accordance with these protocols, and circuitry 200 may de-encapsulate, in accordance with such protocols, data and/or commands from one or more frames received from circuitry 126, via one or more channels associated with these protocols.

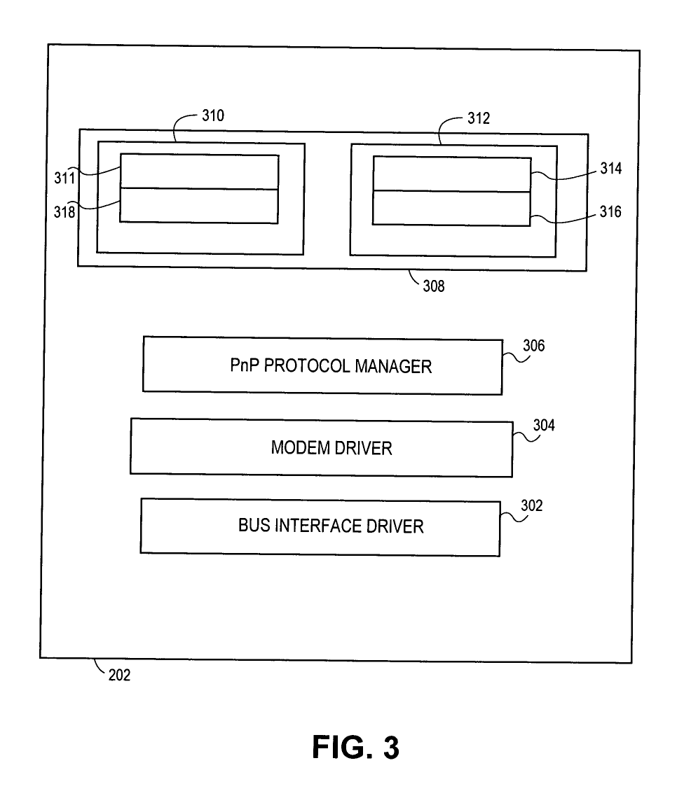

These and other operations 400 that may be carried out in network 100, in accordance with an embodiment, will now be described with reference being made to FIGS. 1 to 4. After, for example, a reset of card 20 and/or system circuitry 200, program processes 202 may comprise bus interface driver 302, modem driver 304, and plug and play (PnP) protocol manager 306. In this embodiment, modem driver 304 may comprise one or more program instructions and data that, when executed and utilized, respectively, by processor 12, circuitry 40, and/or circuitry 42 may permit processor 12 to control operation of circuitry 40 and/or circuitry 42. Bus interface driver 302 may comprise one or more program instructions and data that, when executed and utilized, respectively by processor 12 may permit processor 12 to exchange data and/or commands with circuitry 40 and/or circuitry 42 that may permit such control of circuitry 40 and/or circuitry 42 by processor 12. Protocol manager 306 may comprise one or more program instructions and data that, when executed and utilized, respectively, by processor 12 circuitry 40, and/or circuitry 42 may implement universal plug and play processes techniques that may be compatible and/or comply with processes and techniques disclosed in, for example, “Universal Plug and Play Architecture,” Version 1.0, published 8 Jun. 2000, Microsoft Corporation (available from the UPnP™ Forum).

After a reset of card 20 and/or system circuitry 200, the execution of one or more program instructions and/or utilization of data comprised in driver 304 may result in processor 12 signaling circuitry 40 via bus 22. This may result in circuitry 42 in node 106 initializing communication with circuitry 126 in node 108. In this embodiment, this initialization of communication between circuitry 42 and circuitry 126 may comprise, for example, a negotiation between circuitry 42 and circuitry 126 of one or more parameters specifying and/or identifying the manner in which one or more aspects of the communication is to be carried out between circuitry 42 and circuitry 126. During and/or as part of this negotiation, circuitry 42 may generate and transmit to circuitry 126, via line 110, one or more frames 128. One or more frames 128 may comprise one or more requests 130. One or more requests 130 may request that circuitry 126 indicate to circuitry 42, for each transmission channel via which circuitry 126 may be capable of transmitting one or more frames to circuitry 42 and for each receiver channel via which circuitry 126 may be capable of receiving one or more frames from circuitry 42, the one or more respective predetermined communication protocols associated with each such channel.

After circuitry 126 receives one or more frames 128, circuitry 126 may generate and transmit, in response at least in part to receipt of one or more requests 130, one or more frames 132 to circuitry 42 via line 110. One or more frames 132 may comprise one or more parameters 134. One or more parameters 134 may specify, at least in part, the one or more predetermined communication protocols associated with each of the transmission and receiver channels.

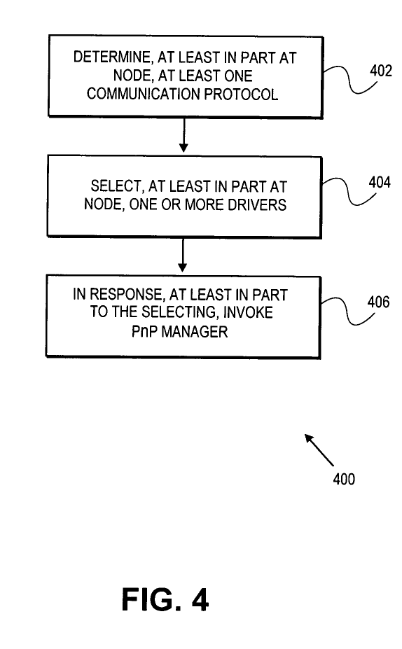

After circuitry 42 receives one or more frames 132, the execution of one or more program instructions and/or utilization of data in driver 304 may result in processor 12, circuitry 40, and/or circuitry 42 examining one or more parameters 134, and determining, at least in part, based at least in part upon one or more parameters 134, one or more communication protocols via which node 108 may be capable of communicating with node 106, as illustrated by operation 402 in FIG. 4. For example, in this embodiment, as part of operation 402, circuitry 40, circuitry 42, and/or processor 12 may determine, at least in part, based at least in part upon one or more parameters 134, the one or more predetermined communication protocols associated with each of the transmission and receiver channels.

Thereafter, the execution of one or more program instructions and/or utilization of data in driver 304 may result in circuitry 40, circuitry 42, and/or processor 12 selecting, at least in part, one or more drivers that may be capable of implementing, at least in part, these one or more predetermined communication protocols, as illustrated by operation 404 in FIG. 4. In this embodiment, as part of operation 404, circuitry 40, circuitry 42 and/or processor 12 may select, at least in part, one or more respective communication protocol drivers 308 whose program instructions and data, when executed and/or utilized, respectively, by processor 12, circuitry 40, and/or circuitry 42 may result in generation, at least in part, of one or more frames that may comply and/or be compatible with these one or more predetermined communication protocols.

For example, in this embodiment, one or more drivers 308 may comprise one or more Ethernet communication protocol drivers 310 and/or one or more ATM communication protocol drivers 312. Protocol drivers 310 may comprise, for example, one or more channel framing drivers 311 and/or one or more encapsulation drivers 318; each of these drivers 311 and 318 may comply and/or be compatible with an Ethernet protocol. Protocol drivers 312 may comprise, for example, one or more channel framing drivers 314 and/or one or more mux and/or encapsulation drivers 316; each of these drivers 314 and 316 may comply and/or be compatible with an ATM protocol.

In this embodiment, in response at least in part to the selecting of one or more drivers 308 as a result of operation 404, the execution of one or more program instructions and/or utilization of data in driver 304 and/or driver 302 may result in circuitry 40, circuitry 42, and/or processor 12 invoking PnP protocol manager 306, as illustrated by operation 406 in FIG. 4. This may result in the loading into memory 21 and/or memory 38 of one or more drivers 308.

Thereafter, processor 12, circuitry 40, and/or circuitry 42 may execute one or more program instructions and/or utilize data comprised in one or more drivers 308. In this embodiment, this may result in circuitry 42 generating and transmitting to circuitry 126 one or more respective frames 136 via one or more respective receiver channels, and may also result in circuitry 42 being capable of receiving one or more frames 140 from circuitry 126 via one or more respective transmission channels.

Each of one or more respective frames 136 may comprise respective data and/or commands 138 that may be encapsulated and/or framed in one or more respective frames 136 in accordance with the one or more respective predetermined communication protocols that are associated with the respective receiver channels. After receiving one or more respective frames 136, circuitry 126 may de-encapsulate and recover respective data and/or commands 138 from one or more respective frames 136.

Each of the one or more respective frames 140 may comprise respective data and/or commands 142 that may be encapsulated and/or framed in one or more respective frames 140 in accordance with the one or more respective predetermined communication protocols that are associated with the respective transmission channels. After receiving one or more respective frames 140, the execution of one or more program instructions and/or utilization of data in one or more drivers 308 may result in circuitry 40, circuitry 42, and/or processor 12 de-encapsulating and recovering respective data and/or commands 142 from one or more respective frames 140.

Thus, a system embodiment may comprise a first node and a second node. The first node may comprise circuitry that includes a circuit card and a circuit board. The circuit board may comprise a circuit card slot that may be capable of coupling the circuit card to the circuit board. The circuitry of this embodiment may be capable of determining, at least in part, at least one communication protocol via which the second node is capable of communicating with the first node. The circuitry of this embodiment also may be capable of determining this at least one communication protocol based at least in part upon at least one parameter received by the circuit card from the second node during an initialization of communication between the first node and the second node. This at least one parameter may specify, at least in part, the at least one communication protocol.

Thus, in this system embodiment, the circuitry is capable of determining one or more communication protocols via which the second node may communicate with the first node. Advantageously, this may permit the first node to be able to communicate with the second node, regardless of whether the user has previous knowledge of the one or more communication protocols via which the second node is capable of communicating with the first node, and without having to utilizing trial-and-error experimentation to determine these one or more communication protocols. Further advantageously, if one or more communication protocols via which the second node may be capable of communicating with the first node changes, the circuitry may be capable of determining that the change has occurred, and also may be capable of appropriately changing one or more communication protocols utilized by the first node to communicate with the second node so as to permit the first node to communicate with the second node.

The terms and expressions which have been employed herein are used as terms of description and not of limitation, and there is no intention, in the use of such terms and expressions, of excluding any equivalents of the features shown and described (or portions thereof), and it is recognized that various modifications, variations, alternatives, and equivalents are possible within the scope of the claims. Accordingly, the claims are intended to cover all such modifications, variations, alternatives, and equivalents.

1. A method comprising:
determining, at least in part at a first node, at least one communication protocol via which a second node is capable of communicating with the first node, the determining being based at least in part upon at least one parameter received from the second node during an initialization of communication between the first node and the second node, the at least one parameter specifying, at least in part, the at least one communication protocol.

2. The method of claim 1, further comprising:
selecting, at least in part at the first node, one or more drivers capable of implementing, at least in part, the at least one communication protocol.

3. The method of claim 2, wherein:
the one or more drivers comprise at least one channel framing driver that is capable of implementing, at least in part, at least one framing protocol that is compatible with at least one of an Ethernet protocol and an Asynchronous Transfer Mode protocol.

4. The method of claim 2, further comprising:
in response at least in part to the selecting, invoking a plug and play (PnP) protocol manager to initiate loading, at least in part, of the one or more drivers into memory.

5. The method of claim 2, wherein:
the one or more drivers are capable of implementing, at least in part, at least one encapsulation protocol that is compatible with an Asynchronous Transfer Mode (ATM) protocol and an Ethernet protocol.

6. The method of claim 1, wherein:
the first node comprises at least one modem driver; and
the determining is performed, at least in part, by the at least one modem driver.

7. The method of claim 1, wherein:
the initialization of the communication comprises a negotiation between the first node and the second node; and
in response at least in part to a request from the first node, the second node transmits during the negotiation the at least one parameter to the first node.

8. An apparatus comprising:
circuitry that is capable of determining, at least in part at a first node, at least one communication protocol via which a second node is capable of communicating with the first node, the circuitry being capable of determining the at least one communication protocol based at least in part upon at least one parameter received by the first node from the second node during an initialization of communication between the first node and the second node, the at least one parameter specifying, at least in part, the at least one communication protocol.

9. The apparatus of claim 8, wherein:
the circuitry is also capable of selecting, at least in part at the first node, one or more drivers capable of implementing, at least in part, the at least one communication protocol.

10. The apparatus of claim 9, wherein:
the one or more drivers comprise at least one channel framing driver that is capable of implementing, at least in part, at least one framing protocol that is compatible with at least one of an Ethernet protocol and an Asynchronous Transfer Mode protocol.

11. The apparatus of claim 9, wherein:
the circuitry is also capable of invoking a plug and play (PnP) protocol manager to initiate loading, at least in part, of the one or more drivers into memory.

12. The apparatus of claim 9, wherein:
the one or more drivers are capable of implementing, at least in part, at least one encapsulation protocol that is compatible with an Asynchronous Transfer Mode (ATM) protocol and an Ethernet protocol.

13. The apparatus of claim 9, wherein:
the circuitry is capable of executing at least one modem driver; and
execution of the at least one modem driver by the circuitry results, at least in part, in the circuitry being capable, at least in part, of determining the at least one communication protocol.

14. The apparatus of claim 8, wherein:
the initialization of the communication comprises a negotiation between the first node and the second node; and
in response at least in part to a request from the first node, the second node transmits during the negotiation the at least one parameter to the first node.

15. An article comprising:
a storage medium having stored thereon instructions that when executed by a machine result in the following:
determining, at least in part at a first node, at least one communication protocol via which a second node is capable of communicating with the first node, the determining being based at least in part upon at least one parameter received from the second node during an initialization of communication between the first node and the second node, the at least one parameter specifying, at least in part, the at least one communication protocol.

16. The article of claim 15, wherein:
the instructions when executed by the machine also result in selecting, at least in part at the first node, one or more drivers capable of implementing, at least in part, the at least one communication protocol.

17. The article of claim 16, wherein:
the one or more drivers comprise at least one channel framing driver that is capable of implementing, at least in part, at least one framing protocol that is compatible with at least one of an Ethernet protocol and an Asynchronous Transfer Mode protocol.

18. The article of claim 16, wherein:
the instructions when executed by the machine also result in, in response at least in part to the selecting of the one or more drivers, invoking a plug and play (PnP) protocol manager to initiate loading, at least in part, of the one or more drivers into memory.

19. The article of claim 16, wherein:
the one or more drivers are capable of implementing, at least in part, at least one encapsulation protocol that is compatible with an Asynchronous Transfer Mode (ATM) protocol and an Ethernet protocol.

20. The article of claim 15, wherein:
the first node comprises at least one modem driver; and
the determining of the at least one communication protocol is performed, at least in part, by the at least one modem driver.

21. The article of claim 15, wherein:
the initialization of the communication comprises a negotiation between the first node and the second node; and
in response at least in part to a request from the first node, the second node transmits during the negotiation the at least one parameter to the first node.

22. A system comprising:
a first node comprising circuitry that includes a circuit card and a circuit board that includes a circuit card slot that is capable of coupling the circuit card to the circuit board; and
a second node;
the circuitry being capable of determining, at least in part, at least one communication protocol via which the second node is capable of communicating with the first node, the circuitry being capable of determining the at least one communication protocol based at least in part upon at least one parameter received by the circuit card from the second node during an initialization of communication between the first node and the second node, the at least one parameter specifying, at least in part, the at least one communication protocol.

23. The system of claim 22, wherein:
the circuit board comprises a bus and a host processor coupled to the bus; and
when the circuit card is coupled to the slot, the circuitry is coupled to the bus.

24. The system of claim 23, wherein:
the circuit card comprises a digital subscriber line (DSL) modem.

25. The system of claim 24, wherein:
a central office (CO) comprises the second node; and
customer premises equipment (CPE) comprises the modem.
